(19) United States
(12) Patent Application Publication
(10) Pub. No.: US 2022/0046503 A1
(43) Pub. Date: Feb. 10, 2022

(54) QUALITY OF EXPERIENCE TECHNIQUES FOR A WIRELESS COMMUNICATION SYSTEM

(71) Applicant: QUALCOMM Incorporated, San Diego, CA (US)

(72) Inventors: RAJEEV KUMAR, San Diego, CA (US); Xipeng Zhu, San Diego, CA (US); Shankar Krishnan, San Diego, CA (US); Gavin Bernard Horn, La Jolla, CA (US)

(21) Appl. No.: 17/357,691

(22) Filed: Jun. 24, 2021

Related U.S. Application Data
(60) Provisional application No. 63/061,567, filed on Aug. 5, 2020.

(51) Int. Cl. H04W 36/08; H04W 76/27; H04W 28/24; H04W 36/00

(52) U.S. Cl. CPC H04W 36/08; H04W 36/0044; H04W 28/24; H04W 76/27

(57) ABSTRACT

A method of wireless communication includes receiving, by a user equipment (UE), a first message indicating one or more quality of experience (QoE) configurations including at least a first QoE configuration for the UE. The method further includes receiving, by the UE, a second message indicating a second QoE configuration for the UE. The method further includes transmitting, by the UE based on one or more of a first priority associated with the first QoE configuration, a second priority associated with the second QoE configuration, or a QoE configuration threshold, a QoE measurement report associated with a particular QoE configuration corresponding to one of the first QoE configuration or the second QoE configuration.

### CROSS-REFERENCE TO RELATED APPLICATION

This application claims the benefit of and priority to U.S. Prov. Pat. App. No. 63/061,567, filed Aug. 5, 2020 and entitled “QUALITY OF EXPERIENCE TECHNIQUES FOR A WIRELESS COMMUNICATION SYSTEM,” the contents of which are incorporated by reference herein in their entirety.

### TECHNICAL FIELD

Aspects of the present disclosure relate generally to wireless communication systems, and more particularly, to quality of experience (UE) techniques for wireless communication systems.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations, or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### SUMMARY

In one aspect of the disclosure, a method of wireless communication includes receiving, by a user equipment (UE), a first message indicating one or more quality of experience (QoE) configurations including at least a first QoE configuration for the UE. The method further includes receiving, by the UE, a second message indicating a second QoE configuration for the UE. The method further includes transmitting, by the UE based on one or more of a first priority associated with the first QoE configuration, a second priority associated with the second QoE configuration, or a QoE configuration threshold, a QoE measurement report associated with a particular QoE configuration corresponding to one of the first QoE configuration or the second QoE configuration.

In another aspect, an apparatus for wireless communication includes a receiver configured to receive, at a UE, configuration data indicating one or more QoE configurations including at least a first QoE configuration. The receiver is further configured to perform, based on the first QoE configuration, QoE measurements associated with a wireless communication network and a base station. The apparatus further includes a transmitter configured to transmit, by the UE based on the one or more QoE measurements, a QoE measurement report with one or more of an indication of a network type of the wireless communication network or cell information associated with the base station.

In another aspect, a method of wireless communication includes receiving, by a first base station, a QoE measurement report from a UE based on a QoE configuration of the UE. The method further includes, based on the QoE configuration, transmitting, by the first base station to a server, a handover message that includes QoE context and QoE reporting data associated with the UE. The handover message is associated with a handover of the UE from the first base station to a second base station, and transmission of the QoE context and QoE reporting data with the handover message enables the second base station to use the QoE configuration based on a determination that an area scope associated with the QoE configuration is satisfied. The method further includes receiving a handover command from the server, and based on the handover command, transmitting a reconfiguration message to the UE to initiate the handover of the UE from the first base station to the second base station.

In another aspect, an apparatus for wireless communication includes a transmitter and a receiver. The receiver is configured to receive, at a first network device based on a radio resource control (RRC) mode transition of a UE, a QoE context associated with the UE from a serving base station of the UE or from a server. The QOE context indicates a QoE configuration associated with the UE, One or both of the transmitter or the receiver are configured to communicate with the UE, after an RRC resume operation associated with the UE or after an RRC connection establishment operation associated with the UE, based on the QoE context.

In another aspect, a method of wireless communication includes receiving, by a user equipment (UE), configuration data indicating one or more quality of experience (QoE) configurations including at least a first QoE configuration. The method further includes generating, by the UE, a QoE measurement report associated with the first QoE configuration and receiving, by the UE from a network device, a message indicating a second QoE configuration. The method further includes determining, based on one or more of a first priority associated with the first QoE configuration, a second priority associated with the second QoE configuration, or a QoE configuration threshold, whether to release the first QoE configuration or the second QOE configuration.

In another aspect, a non-transitory computer readable medium stores instructions executable by a processor to perform operations. The operations include receiving, by a UE, configuration data indicating one or more QoE configurations including at least a first QoE configuration. The operations further include generating, by the UE, a QoE measurement report associated with the first QoE configuration and receiving, by the UE from a network device, a message indicating a second QoE configuration. The operations further include determining, based on one or more of a first priority associated with the first QoE configuration, a second priority associated with the second QoE configuration, or a QoE configuration threshold, whether to release the first QoE configuration or the second QOE configuration.

In another aspect, an apparatus includes a memory and one or more processors coupled to the memory. The one or more processors are configured to receive, by a UE, configuration data indicating one or more QoE configurations including at least a first QoE configuration. The one or more processors are further configured to generate, by the UE, a QoE measurement report associated with the first QoE configuration and to receive, by the UE from a network device, a message indicating a second QoE configuration. The one or more processors are further configured to determine, based on one or more of a first priority associated with the first QoE configuration, a second priority associated with the second QoE configuration, or a QoE configuration threshold, whether to release the first QoE configuration or the second QOE configuration.

In another aspect, an apparatus includes means for receiving, by a UE, configuration data indicating one or more QoE configurations including at least a first QoE configuration. The apparatus further includes means for generating, by the UE, a QoE measurement report associated with the first QoE configuration and means for receiving, by the UE from a network device, a message indicating a second QoE configuration. The apparatus further includes means for determining, based on one or more of a first priority associated with the first QoE configuration, a second priority associated with the second QoE configuration, or a QoE configuration threshold, whether to release the first QoE configuration or the second QOE configuration.

In another aspect, a method of wireless communication includes receiving, by a UE, configuration data indicating one or more QoE configurations including at least a first QoE configuration, determining, based on the first QoE configuration and by the UE, QoE measurements associated with a wireless communication network and a base station, and generating, by the UE, a QoE measurement report based on one or more of the QoE measurements. The method further includes transmitting, by the UE to a network device, the QoE measurement report with one or more of an indication of a network type of the wireless communication network or cell information associated with the base station.

In another aspect, a non-transitory computer-readable medium stores instructions executable by a processor to perform operations. The operations include receiving, by a UE, configuration data indicating one or more QoE configurations including at least a first QoE configuration, determining, based on the first QoE configuration and by the UE, QoE measurements associated with a wireless communication network and a base station, and generating, by the UE, a QoE measurement report based on one or more of the QoE measurements. The operations further include transmitting, by the UE to a network device, the QoE measurement report with one or more of an indication of a network type of the wireless communication network or cell information associated with the base station.

In another aspect, an apparatus includes a memory and one or more processors coupled to the memory. The one or more processors are configured to receive, by a UE, configuration data indicating one or more QoE configurations including at least a first QoE configuration, to determine, based on the first QoE configuration, QoE measurements associated with a wireless communication network and a base station, and to generate, by the UE, a QoE measurement report based on one or more of the QoE measurements. The one or more processors are further configured to transmit, by the UE to a network device, the QoE measurement report with one or more of an indication of a network type of the wireless communication network or cell information associated with the base station.

In another aspect, an apparatus includes means for receiving, by a UE, configuration data indicating one or more QoE configurations including at least a first QoE configuration, means for determining, based on the first QoE configuration and by the UE, QoE measurements associated with a wireless communication network and a base station, and means for generating, by the UE, a QoE measurement report based on one or more of the QoE measurements. The apparatus further includes means for transmitting, by the UE to a network device, the QoE measurement report with one or more of an indication of a network type of the wireless communication network or cell information associated with the base station.

In another aspect, a method of wireless communication includes receiving, by a first base station, QoE data from a UE, transmitting, based on the QoE data and by the first base station to a server, a handover message that includes QoE context data associated with the UE, and receiving a handover command from the server. The method further includes, based on the handover command, transmitting a reconfiguration message to the UE to initiate a handover of the UE from the first base station to a second base station.

In another aspect, a non-transitory computer-readable medium stores instructions executable by a processor to perform operations. The operations include receiving, by a first base station, QoE data from a UE, transmitting, based on the QoE data and by the first base station to a server, a handover message that includes QoE context data associated with the UE, and receiving a handover command from the server. The operations further include, based on the handover command, transmitting a reconfiguration message to the UE to initiate a handover of the UE from the first base station to a second base station.

In another aspect, an apparatus includes a memory and one or more processors coupled to the memory. The one or more processors are configured to receive, by a first base station, QoE data from a UE, to transmit, based on the QoE data and by the first base station to a server, a handover message that includes QoE context data associated with the UE, and to receive a handover command from the server. The one or more processors are further configured to transmit, based on the handover command, a reconfiguration message to the UE to initiate a handover of the UE from the first base station to a second base station.

In another aspect, an apparatus includes means for receiving, by a first base station, QoE data from a UE, means for transmitting, based on the QoE data by the first base station to a server, a handover message that includes QoE context data associated with the UE, and means for receiving a handover command from the server. The apparatus further includes means for transmitting, based on the handover command, a reconfiguration message to the UE to initiate a handover of the UE from the first base station to a second base station.

In another aspect, a method of wireless communication includes communicating, by a base station, with a UE and receiving, by the base station from a server, a handover request for the UE. The handover request includes QoE context data associated with the UE and indicates an area scope. The method further includes transmitting, based on detection that the area scope is satisfied and by the base station, a handover response to the server.

In another aspect, a non-transitory computer-readable medium stores instructions executable by a processor to perform operations. The operations include communicating, by a base station, with a UE and receiving, by the base station from a server, a handover request for the UE. The handover request includes QoE context data associated with the UE and indicates an area scope. The operations further include, based on detection that the area scope is satisfied, transmitting, by the base station, a handover response to the server.

In another aspect, an apparatus includes a memory and one or more processors coupled to the memory. The one or more processors are configured to communicate, by a base station, with a UE and to receive, by the base station from a server, a handover request for the UE. The handover request includes QoE context data associated with the UE and indicates an area scope. The one or more processors are further configured to transmit, based on detection that the area scope is satisfied, a handover response by the base station to the server.

In another aspect, an apparatus includes means for communicating, by a base station, with a UE and means for receiving, by the base station from a server, a handover request for the UE. The handover request includes QoE context data associated with the UE and indicates an area scope. The apparatus further includes means for transmitting, based on detection that the area scope is satisfied, a handover response by the base station to the server.

In another aspect, a method of wireless communication includes transmitting, by a first network device to a UE, configuration data indicating one or more QoE configurations including at least a first QoE configuration and receiving, by the first network device from the UE, a QoE measurement report generated based on the first QoE configuration. The method further includes receiving, based on a mode transition of the UE and from a second network device, a QoE context request associated with the UE. The method further includes, based on the QoE context request, transmitting, by the first network device to the second network device, a QoE context message associated with the UE. The QoE context message indicates that the first QoE configuration is associated with the UE.

In another aspect, a non-transitory computer-readable medium stores instructions executable by a processor to perform operations. The operations include transmitting, by a first network device to a UE, configuration data indicating one or more QoE configurations including at least a first QoE configuration and receiving, by the first network device from the UE, a QoE measurement report generated based on the first QoE configuration. The operations further include receiving, based on a mode transition of the UE and from a second network device, a QoE context request associated with the UE and transmitting, based on the QoE context request and by the first network device to the second network device, a QoE context message associated with the UE. The QoE context message indicates that the first QoE configuration is associated with the UE.

In another aspect, an apparatus includes a memory and one or more processors coupled to the memory. The one or more processors are configured to transmit, by a first network device to a UE, configuration data indicating one or more QoE configurations including at least a first QoE configuration and to receive, by the first network device from the UE, a QoE measurement report generated based on the first QoE configuration. The one or more processors are further configured to receive, based on a mode transition of the UE and from a second network device, a QoE context request associated with the UE and to transmit, based on the QoE context request and by the first network device to the second network device, a QoE context message associated with the UE. The QoE context message indicates that the first QoE configuration is associated with the UE.

In another aspect, an apparatus includes means for transmitting, by a first network device to a UE, configuration data indicating one or more QoE configurations including at least a first QoE configuration and means for receiving, by the first network device from the UE, a QoE measurement report generated based on the first QoE configuration. The apparatus further includes means for receiving, based on a mode transition of the UE and from a second network device, a QoE context request associated with the UE and means for transmitting, based on the QoE context request and by the first network device to the second network device, a QoE context message associated with the UE. The QoE context message indicates that the first QoE configuration is associated with the UE.

In another aspect, a method of wireless communication includes transmitting, by a first network device to a UE, configuration data indicating one or more QoE configurations including at least a first QoE configuration and receiving, by the first network device from the UE, a QoE measurement report generated based on the first QoE configuration. The method further includes receiving, by the first network device from a server, a context release command associated with the UE. The method further includes, based on the context release command, transmitting a release message to the UE and transmitting a QoE context message associated with the UE to the server.

In another aspect, a non-transitory computer-readable medium stores instructions executable by a processor to perform operations. The operations include transmitting, by a first network device to a UE, configuration data indicating one or more QoE configurations including at least a first QoE configuration and receiving, by the first network device from the UE, a QoE measurement report generated based on the first QoE configuration. The operations further include receiving, by the first network device from a server, a context release command associated with the UE. The operations further include, based on the context release command, transmitting a release message to the UE and transmitting a QoE context message associated with the UE to the server.

In another aspect, an apparatus includes a memory and one or more processors coupled to the memory. The one or more processors are configured to transmit, by a first network device to a UE, configuration data indicating one or more QoE configurations including at least a first QoE configuration. The one or more processors are further configured to receive, by the first network device from the UE, a QoE measurement report generated based on the first QoE configuration and to receive, by the first network device from a server, a context release command associated with the UE. The one or more processors are further configured to transmit, based on the context release command, a release message to the UE and a QoE context message associated with the UE to the server.

In another aspect, an apparatus includes means for transmitting, by a first network device to a UE, configuration data indicating one or more QoE configurations including at least a first QoE configuration. The apparatus further includes means for receiving, by the first network device from the UE, a QoE measurement report generated based on the first QoE configuration and means for receiving, by the first network device from a server, a context release command associated with the UE. The apparatus further includes means for transmitting, based on the context release command and by the first network device to the UE, a release message and means for transmitting, based on the context release command and by the first network device to the server, a QoE context message associated with the UE.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating an example of a wireless communication system according to some aspects of the disclosure.

FIG. 2 is a block diagram conceptually illustrating examples of a base station and a UE according to some aspects of the disclosure.

FIG. 3 is a ladder diagram illustrating examples of operations that may be performed by a wireless communications system according to some aspects of the disclosure.

FIG. 4 is another ladder diagram illustrating examples of operations that may be performed by a wireless communications system according to some aspects of the disclosure.

FIG. 5A is another ladder diagram illustrating examples of operations that may be performed by a wireless communications system according to some aspects of the disclosure.

FIG. 5B is another ladder diagram illustrating examples of operations that may be performed by a wireless communications system according to some aspects of the disclosure.

FIG. 6A is another ladder diagram illustrating examples of operations that may be performed by a wireless communications system according to some aspects of the disclosure.

FIG. 6B is another ladder diagram illustrating examples of operations that may be performed by a wireless communications system according to some aspects of the disclosure.

FIG. 7 is a flow chart of a method of wireless communication that may be performed by a UE according to some aspects of the disclosure.

FIG. 8 is a block diagram illustrating an example of a UE according to some aspects of the disclosure.

FIG. 9 is a block diagram illustrating an example of a base station according to some aspects of the disclosure.

### DETAILED DESCRIPTION

Wireless communication systems may use quality of experience (QoE) measurements and QoE reporting to enhance communications provided to a user equipment (UE) device. For example, the UE may perform QoE measurements and may report the QoE measurements to a network device (such as a base station) to enable the network device to provide the UE a particular level of data communication speed, call quality, or other performance metrics.

In some cases, continuity of QoE service provided to a UE may be interrupted due to one or more circumstances. For example, in some cases, a network device may not recognize QoE measurements provided by a UE, such as after a handover from a first network device associated with a first radio access technology (RAT) to a second network device associated with a second RAT. As an illustrative example, the first RAT may correspond to one of a fourth generation long term evolution (4G LTE) wireless communication protocol or a fifth generation new radio (5G NR) wireless communication protocol, and the second RAT may correspond to the other of the 4G LTE wireless communication protocol or the 5G NR wireless communication protocol. In such examples, the second network device may discard (or “drop”) the QoE measurements (e.g., due to the different RATs associated with the network devices) instead of using the QoE measurements to provide a certain level of QoE service to the UE.

One or more techniques in accordance with some aspects of the disclosure improve or enable continuity of QoE service in a wireless communication network. In some implementations, the one or more techniques may include forwarding a QoE context associated with a UE from one network device to another network device. For example, during a handover from a first base station to a second base station, the first base station may provide the QoE context to another device, such as a mobility management entity (MME) server. The MME server may forward the QoE context to the second base station, which may enable the second base station to “understand” QoE measurements performed by the UE and transmitted by the UE to the second base station. As a particular example, the QoE context may indicate a particular QoE configuration used by the UE to perform the QoE measurements. As a result, the second base station may be better able to interpret the QoE measurements provided by the UE, which may reduce or avoid instances of the second base station “dropping” QoE measurements reported by the UE.

Further, in some wireless communication protocols, use of multiple QoE configurations may not be supported or defined. In some cases, one or more base stations may attempt to configure the UE with multiple QoE configurations. For example, a first base station may configure the UE with a first QoE configuration, and a second base station may attempt to configure the UE with a second QoE configuration (e.g., after a handover of the UE from the first base station to the second base station). Because multiple QoE configurations may not be supported or defined in some wireless communication protocols, different UEs may respond in various ways to the multiple QoE configurations. In some aspects of the disclosure, a UE is configured to determine a priority associated with a QoE configuration. If a number of QoE configurations of the UE exceeds a threshold, the UE may selectively release one or more QoE configurations (e.g., by releasing a lower-priority QoE configuration, such as by ceasing to perform QoE measurements based on the lower-priority QoE configuration and by replacing the lower-priority QoE configuration with the higher-priority QoE configuration).

By selectively releasing the first QoE configuration or the second QoE configuration, the UE may reduce a number of QoE measurements performed or a number of measurement reports generated and transmitted to a base station. For example, by releasing the first QoE configuration in favor of the second QoE configuration, the UE may perform one set of QoE measurements (for the second QoE configuration) instead of concurrently performing multiple sets of QoE measurements (for both the first QoE configuration and the second QoE configuration). As a result, power consumption and utilization of network resources by the UE may be reduced as compared to other techniques that perform a relatively large number of QoE measurements or that generate and transmit a relatively large number of measurement reports. Other aspects are described further below.

To further illustrate, the disclosure relates generally to wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks/systems/devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The Third Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with Universal Terrestrial Radio Access Networks (UTRANs) in the case of a UMTS/GSM network. Additionally, an operator network may also include one or more LTE networks, and/or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. One or more aspects of the present disclosure may be related to shared access to the wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km\hat{ }2), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km\hat{ }2), extreme data rates (e.g., multi-Gbps rate, 100+ Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD)/frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chips and/or other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or OEM devices or systems incorporating one or more described aspects. It is intended that innovations described herein may be practiced in a wide variety of implementations, including both large/small devices, chip-level components, multi-component systems (e.g. RF-chain, communication interface, processor), distributed arrangements, end-user devices, etc. of varying sizes, shapes, and constitution.

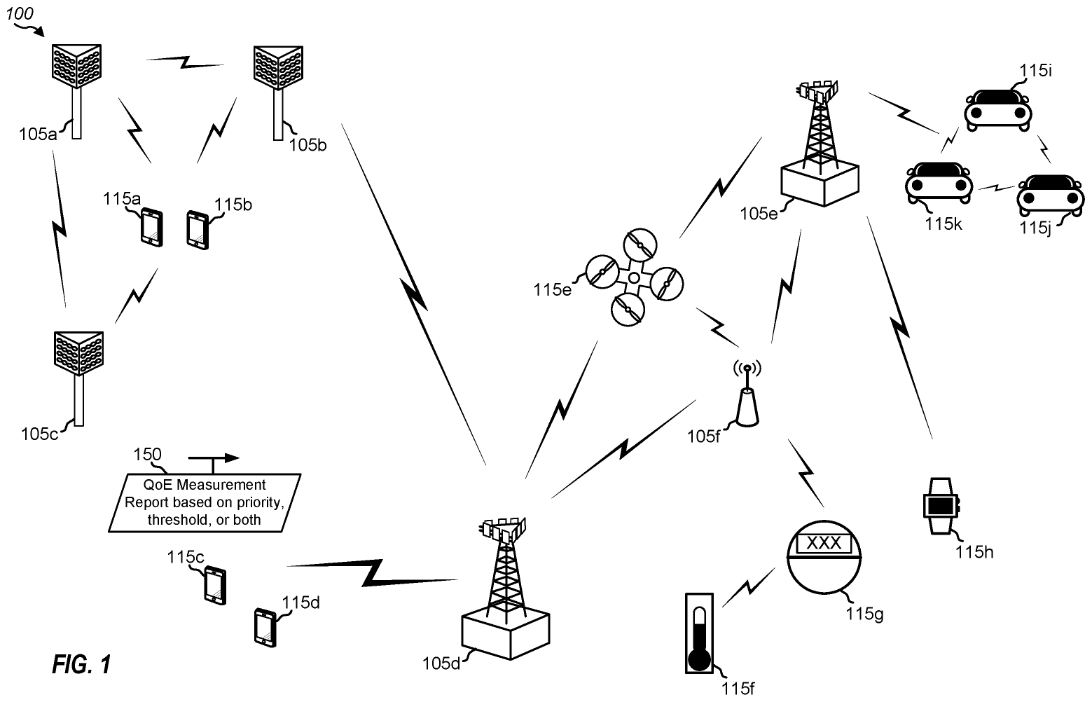

FIG. 1 is a block diagram illustrating details of an example wireless communication system. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station and/or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as user equipment (UE) in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component device/module, or some other suitable terminology. Within the present document, a “mobile” apparatus or UE need not necessarily have a capability to move and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink and/or uplink, or desired transmission between base stations, and backhaul transmissions between base stations. UEs may operate as base stations or other network nodes in some scenarios. Backhaul communication between base stations of wireless network 100 may occur using wired and/or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such as UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD/FDD communications, such as in a vehicle-to-vehicle (V2V) mesh network between UEs 115i-115k communicating with macro base station 105e.

In some aspects, one or more features described herein may enable a UE 115 to select a QoE configuration for QoE measurements based on a priority associated with the QoE configuration, based on a number of QoE configurations associated with the UE 115 failing to exceed a threshold number of QoE configurations, or both. The UE 115 may transmit a QoE measurement report 150 that is based on the particular QoE configuration, as described further below.

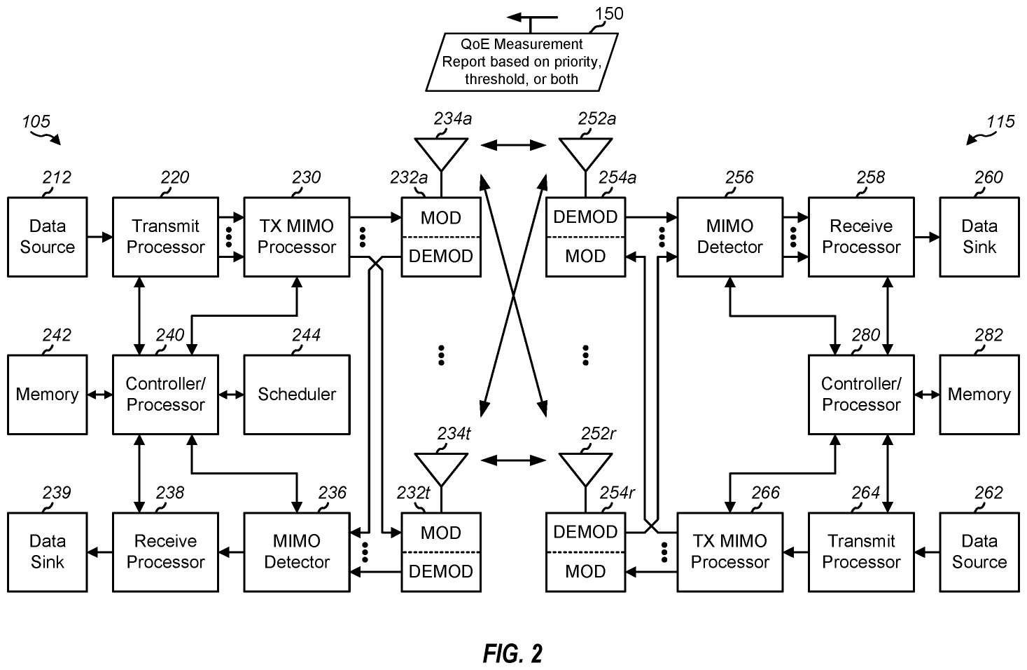

FIG. 2 shows a block diagram conceptually illustrating an example design of a base station 105 and a UE 115, which may be any of the base stations and one of the UEs in FIG. 1. For a restricted association scenario (as mentioned above), base station 105 may be small cell base station 105f in FIG. 1, and UE 115 may be UE 115c or 115D operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller/processor 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), MTC physical downlink control channel (MPDCCH), etc. The data may be for the PDSCH, etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) multiple-input multiple-output (MIMO) processor 230 may perform spatial processing (e.g., precoding) on the data symbols, the control symbols, and/or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, the antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller/processor 280.

On the uplink, at UE 115, transmit processor 264 may receive and process data (e.g., for the physical uplink shared channel (PUSCH)) from data source 262 and control information (e.g., for the physical uplink control channel (PUCCH)) from controller/processor 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Processor 238 may provide the decoded data to data sink 239 and the decoded control information to controller/processor 240.

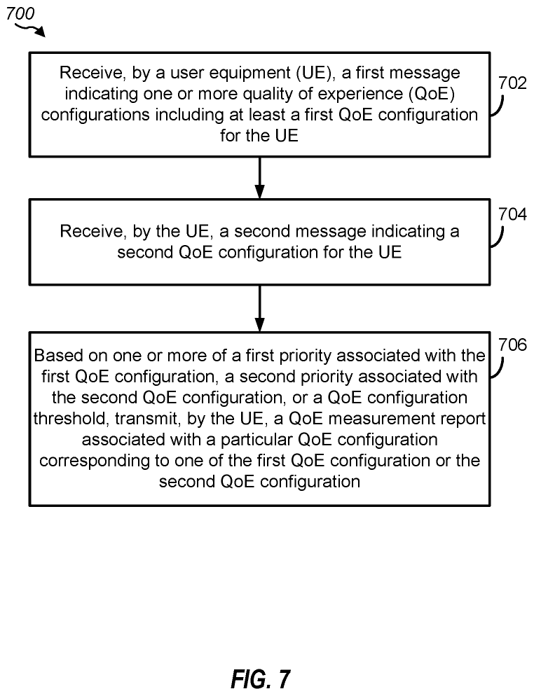

Controllers/processors 240 and 280 may direct the operation at base station 105 and UE 115, respectively. Controller/processor 240 and/or other processors and modules at base station 105 and/or controller/processor 280 and/or other processors and modules at UE 115 may perform or direct the execution of various processes for the techniques described herein, such as to perform or direct the execution illustrated in FIG. 7, and/or other processes for the techniques described herein (e.g., transmission of the QoE measurement report 150). Memories 242 and 282 may store data and program codes for base station 105 and UE 115, respectively. Scheduler 244 may schedule UEs for data transmission on the downlink and/or uplink.

Wireless communications systems operated by different network operating entities (e.g., network operators) may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure, such as a clear channel assessment (CCA), prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel and/or the acknowledge/negative-acknowledge (ACK/NACK) feedback for its own transmitted packets as a proxy for collisions.

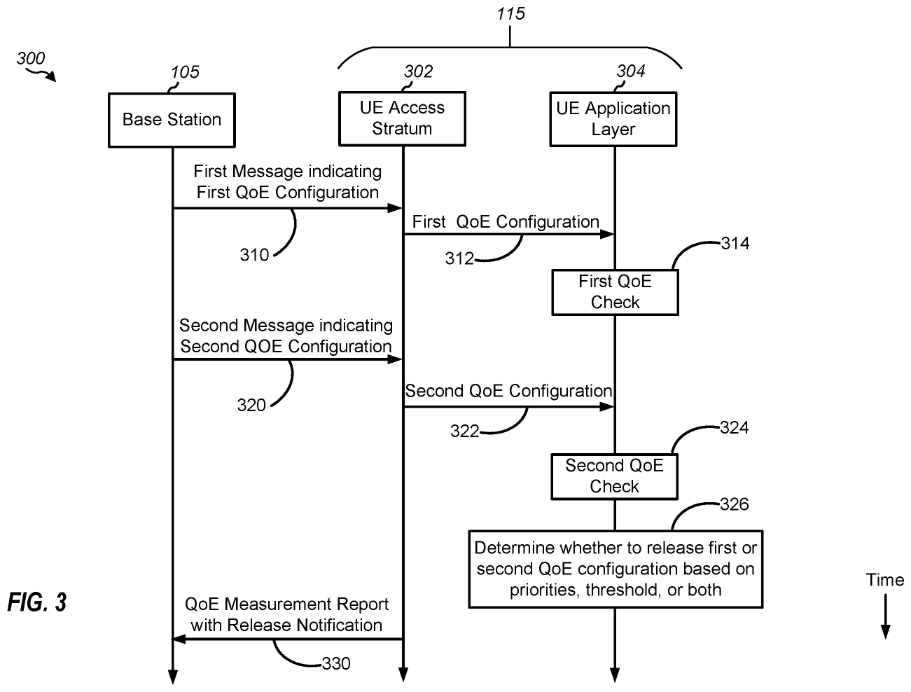

FIG. 3 is a ladder diagram illustrating operations 300 that may be performed by a wireless communications system according to some aspects of the disclosure. The operations 300 may be performed by a network device (e.g., the base station 105) and by a UE, such as the UE 115. In the example of FIG. 3, the UE 115 may include, or may execute instructions of, a UE access stratum 302 and a UE application layer 304.

The operations 300 may include transmitting, by the base station 105, a first message (e.g., a message including configuration data) indicating one or more QoE configurations including at least a first QoE configuration, at 310. The UE 115 may receive the first message via the UE access stratum 302 and may provide the configuration data (or at least a portion of the configuration data, such as the first QoE configuration) to the UE application layer 304, at 312.

The UE application layer 304 may perform a first check associated with the first QoE configuration, at 314. For example, the UE application layer 304 may determine whether the first QoE configuration was previously configured, may identify a first priority associated with the first QoE configuration, or may determine whether a number of QoE configurations associated with the UE 115 satisfies a QoE configuration threshold. To illustrate, if the UE 115 was previously not configured with any QoE configurations, then the UE application layer 304 may determine to perform QoE measurements based on the first QoE configuration. In this case, the first QoE check may indicate that the UE 115 is to perform QoE measurements based on the first QoE configuration. In some examples, the configuration data received from the base station 105 (or one or more other configuration messages) indicate the first priority, the QoE configuration threshold, or both.

In response to the first QoE check indicating the first QoE configuration, the UE 115 may perform the QoE measurements based on the first QoE configuration. Based on the QoE measurements, the UE 115 may generate a QoE measurement report associated with the first QoE configuration (e.g., the QoE measurement report 150 or another QoE measurement report). In some examples, the QoE measurements may include minimization of drive time (MDT) measurements, and the QoE measurement report includes the MDT measurements. In some implementations, the UE 115 may store the QoE measurement report until releasing the first QoE configuration, at which time the UE 115 may initiate transmission of the QoE measurement report to the base station 105, as described further below.

The operations 300 may further include transmitting, by the base station 105 (or another base station), a second message indicating a second QoE configuration, at 320. The UE 115 may receive the message via the UE access stratum 302 and may provide an indication of the second QoE configuration to the UE application layer 304, at 322.

The UE application layer 304 may perform a second QoE check associated with the second QoE configuration, at 324. For example, the UE application layer 304 may determine whether the second QoE configuration was previously configured, may identify a second priority associated with the first QoE configuration, or may determine whether a number of QoE configurations satisfies the QoE configuration threshold. To illustrate, the UE application layer 304 may determine whether the second priority exceeds the first priority or whether a number of QoE configurations (including the first QoE configuration and the second QoE configuration) exceeds the QoE configuration threshold. In some examples, the second message received from the base station 105 indicates one or more of the second priority or the QoE configuration threshold.

Based on one or more of the first priority, the second priority, or the QoE configuration threshold, the UE 115 may determine whether to release the first QoE configuration or the second QOE configuration, at 326. For example, if the second priority exceeds the first priority and if the number of QoE configurations of the UE 115 satisfies the QoE configuration threshold, then the UE 115 may release the first QoE configuration and may transmit the QoE measurement report to the base station 105, at 330. In this case, in response to determining to release the first QoE configuration, the UE 115 may transmit a release notification with the QoE measurement report indicating release of the first QoE configuration. Further, in this example, the first QoE configuration may be released and may be replaced by the second QoE configuration based on one or more of the second priority exceeding the first priority or a number of QoE configurations associated with the UE exceeding the QoE configuration threshold.

In some examples, releasing a QoE configuration may include transmitting a QoE measurement report associated with the QoE configuration and terminating performing QoE measurements associated with the QoE configuration. For example, releasing the first QoE configuration may include transmitting the QoE measurement report associated with the first QoE configuration, terminating performing QoE measurements associated with the first QoE configuration, and replacing the first QoE configuration with the second QoE configuration. In some examples, releasing the first QoE configuration includes deleting the first QoE configuration from the UE 115 (e.g., at the memory 282 of FIG. 2).

In another example, if the first priority exceeds the second priority and if the number of QoE configurations of the UE 115 satisfies the QoE configuration threshold, then the UE 115 may release the second QoE configuration. For example, releasing the second QOE configuration may include maintaining the QoE measurement report associated with the first QoE configuration, continuing to perform one or more QoE measurements associated with the first QoE configuration, and deleting the second QoE configuration from the UE 115 (e.g., at the memory 282 of FIG. 2). In some examples, the UE 115 transmits a release notification associated with the second QoE configuration indicating release of the second QoE configuration. In some examples, if the UE 115 has performed one or more QoE measurements based on the second QoE configuration prior to releasing the second QoE configuration, the UE 115 may transmit a second measurement report indicating the one or more QoE measurements. In some other examples, if the UE 115 has not performed any QoE measurements based on the second QoE configuration prior to releasing the second QoE configuration, no measurement report may be transmitted based on the second QoE configuration.

In an additional example, if the number of QoE configurations of the UE 115 fails to satisfy the QoE configuration threshold, then the UE 115 may maintain both the first QoE configuration and the second QoE configuration. As an illustrative example, if the QoE configuration threshold corresponds to three QoE configurations, and if the UE 115 stores two QoE configurations (such as the first QoE configuration and the second QoE configuration), then the UE 115 may store both the first QOE configuration and the second QoE configuration (e.g., at the memory 282 of FIG. 2). In such examples, the UE 115 may perform QoE measurements based on a selected QoE configuration having the greatest priority. For example, the UE 115 may perform QoE measurements based on the first QoE configuration if the first priority is greater than the second priority. As another example, the UE 115 may perform QoE measurements based on the second QoE configuration if the second priority is greater than the first priority.

In some examples, a wireless communication protocol specifies one or more of the first priority, the second priority, or the QoE configuration threshold. For example, the base station 105 and the UE 115 may operate in accordance with a wireless communication protocol that specifies that the base station 105 is to configure the UE 115 with one or more of the first priority, the second priority, or the QoE configuration threshold. In some such examples, the base station 105 may transmit one or more configuration messages indicating one or more of the first priority, the second priority, or the QoE configuration threshold (e.g., by transmitting a radio resource control (RRC) configuration message during an RRC setup procedure with the UE 115).

In some other implementations, use of one or more of the first priority, the second priority, or the QoE configuration threshold may be implemented optionally by the UE 115 independently of the wireless communication protocol. In this case, one or more of the first priority, the second priority, or the QoE configuration threshold may be specific to the UE 115. To further illustrate, in some examples, the UE 115 may determine (or select) one or more of the first priority, the second priority, or the QoE configuration threshold. As an illustrative example, the UE 115 may select the QoE configuration threshold based on a storage capacity of a memory of the UE 115 (such as the memory 282). In some examples, the UE 115 may transmit a message (e.g., a UE capability message) to the base station 105 indicating one or more of the first priority, the second priority, or the QoE configuration threshold.

In some examples, QoE configurations of the UE 115 are associated with respective applications (e.g., programs) executed by the UE 115. To illustrate, the UE 115 may concurrently execute a first application and a second application. For example, the UE 115 may include one or more processors (such as the controller/processor 280 of FIG. 2) that concurrently execute the first application and the second application. The first application may be associated with the first QoE configuration and a first service type, and the second application may be associated with the second QoE configuration and a second service type.

By selectively releasing the first QoE configuration or the second QoE configuration as described with reference to FIG. 3, the UE 115 may reduce a number of QoE measurements performed or a number of measurement reports generated and transmitted to the base station 105. For example, by releasing the first QoE configuration in favor of the second QoE configuration, the UE 115 may perform one set of QoE measurements (for the second QoE configuration) instead of concurrently performing multiple sets of QoE measurements (for both the first QoE configuration and the second QoE configuration). As a result, power consumption and utilization of network resources by the UE 115 may be reduced as compared to other techniques that perform a relatively large number of QoE measurements or that generate and transmit a relatively large number of measurement reports.

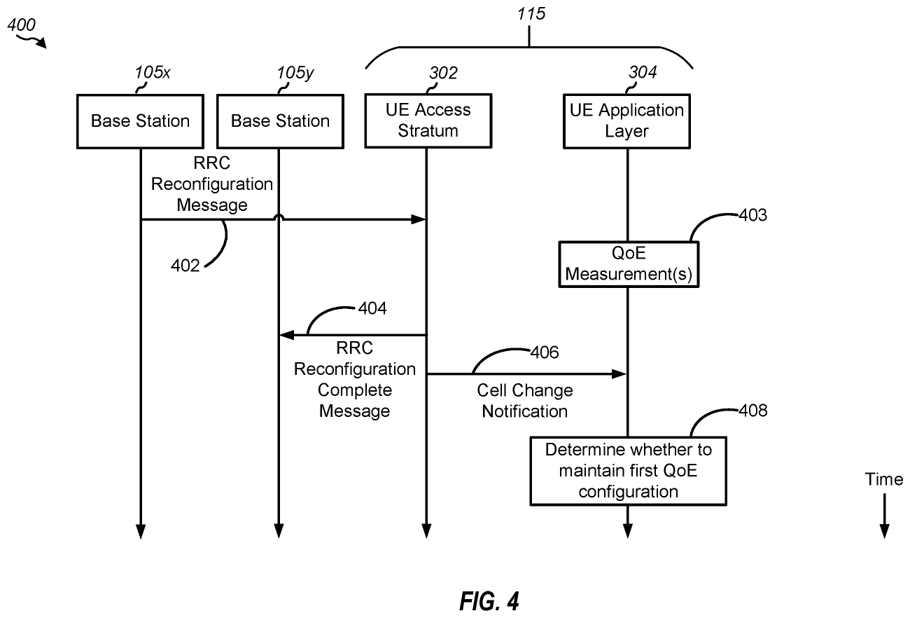

FIG. 4 is a ladder diagram illustrating operations 400 that may be performed by a wireless communications system according to some aspects of the disclosure. The operations 400 may be performed by one or more network devices, such as a base station 105x (e.g., one of the base stations 105a-105e of FIG. 1), by a base station 105y (e.g., another of the base stations 105a-105e of FIG. 1), and by a UE, such as the UE 115.

The base station 105x may be associated with a first radio access technology (RAT), and the base station 105y may be associated with a second RAT that is different than the first RAT. In one example, the first RAT corresponds to one of a fourth generation long term evolution (4G LTE) wireless communication protocol or a fifth generation new radio (5G NR) wireless communication protocol, and the second RAT corresponds to the other of the 4G LTE wireless communication protocol or the 5G NR wireless communication protocol.

During operation, the UE 115 may communicate with the base station 105x. For example, the UE 115 may receive configuration data indicating one or more QoE configurations including at least a first QoE configuration. The UE 115 may determine, based on the first QoE configuration, QoE measurements associated with a wireless communication network and the base station 105x, at 403. For example, the UE 115 may perform the one or more QoE measurements according to the first QoE configuration to determine one or more characteristics of a communication network supported by the base station 105x, which may correspond to the wireless network 100 of FIG. 1. The UE 115 may generate a QoE measurement report (e.g., the QoE measurement report 150 or another QoE measurement report) based on the one or more QoE measurements. In some aspects of the disclosure, the UE 115 transmits the QoE measurement report to a network device with one or more of an indication of a network type of the wireless communication network associated with the QoE measurement report or cell-specific information associated with the QoE measurement report, such as cell information that identifies the base station 105x.

To illustrate, in one example, the indication of the network type includes a flag having a value indicating whether the wireless communication network corresponds to a 4G LTE wireless communication protocol or a 5G NR wireless communication protocol. In this example, the indication may specify whether the QoE measurement report includes measurements performed over a 4G LTE wireless communication network or over a 5G NR wireless communication network.

Alternatively, or in addition, the UE 115 may provide the cell information with the QoE measurement report in response to a handover from the base station 105x to the base station 105y. To illustrate, the UE 115 may receive, at 402, a radio resource control (RRC) reconfiguration message indicating handover from a first cell corresponding to the base station 105x to a second cell corresponding to the base station 105y. The UE 115 may perform one or more operations to facilitate the handover, such as one or more RRC reconfiguration operations. The UE 115 may send an RRC reconfiguration complete message to the base station 105y, at 404. In some examples, the RRC reconfiguration complete message includes one or more of the QoE measurement report, the indication of the network type of the wireless communication network associated with the QoE measurement report, or the cell information that identifies the base station 105x.

In some examples, the UE access stratum 302 provides a cell change notification to the UE application layer 304, at 406. The cell change notification may indicate one or more of a global cell ID (GCI) of the base station 105y or a flag having a value indicating a handover type of the handover (e.g., to indicate whether the handover is from a 5G NR wireless communication network to a 4G LTE wireless communication network (or vice versa)). The UE application layer 304 may provide the cell change notification (or another message) to an application client of the UE 115.

The UE application layer may determine, at 408, whether to maintain (e.g., “re-use”) or discard the first QoE configuration. In some aspects, the cell change notification may enable the UE 115 to “re-use” the first QoE configuration in some circumstances (e.g., based on a particular value of the flag or based on a particular handover type of the handover). In such examples, performance may be enhanced as compared to some other techniques that discard a QoE configuration for each handover. In some other examples, based on the cell change notification, the UE 115 may discard the first QoE configuration (e.g., based on another value of the flag or based on a another handover type of the handover).

In some examples, certain operations described with reference to FIG. 4 are performed for inter-RAT handovers (between base stations associated with different RATs) but not for intra-RAT handovers (between base stations associated the same RAT). In this example, in response to determining that the base station 105x and the base station 105y are associated with different RATs, the UE 115 may transmit the QoE measurement report with one or more of the indication of the network type of the wireless communication network associated with the QoE measurement report or the cell information that identifies the base station 105x. In some other examples, certain operations described with reference to FIG. 4 are performed both for inter-RAT handovers (between base stations associated with different RATs). In this example, the UE 115 may transmit the QoE measurement report with one or more of the indication of the network type of the wireless communication network associated with the QoE measurement report or the cell information that identifies the base station 105x irrespective of whether the base station 105x and the base station 105y are associated with the same RAT or different RATs.

In some aspects, the UE 115 operates based on a multi-radio access network dual connectivity (MR-DC) mode, and one or more operations described with reference to FIG. 4 can be performed in connection with the MR-DC mode. To illustrate, the base station 105x may correspond to a master node (MN) associated with the MR-DC mode, and the cell information provided with the QoE measurement report may include a master node cell global identifier (MN CGI) of the MN. The base station 105y may correspond to a secondary node (SN) associated with the MR-DC mode, the UE 115 may communicate with the SN in connection with the MR-DC mode, and the cell information may include a secondary node cell global identifier (SN CGI) of the SN. In response to removal of the SN from the MR-DC mode, the UE 115 may remove the SN CGI from the QoE measurement report.

One or more aspects of FIG. 4 may improve operation of a wireless communication system. For example, by indicating characteristics of a network or a base station associated with QoE measurements, a network device may be better able to interpret the QoE measurements, such as when determining whether a handover is to be initiated. As an example, by adding cell specific information to a QoE measurement report, a network device may determine that the base station is associated with a particular level of QoE. The network device may use the particular level of QoE when determining whether to perform a handover of a UE to the base station while maintaining a particular QoE for the UE.

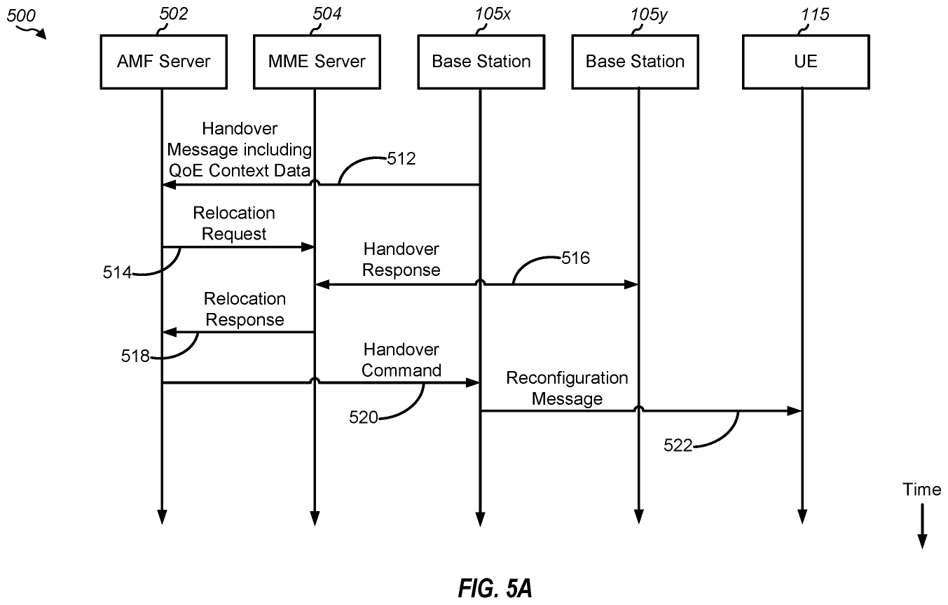

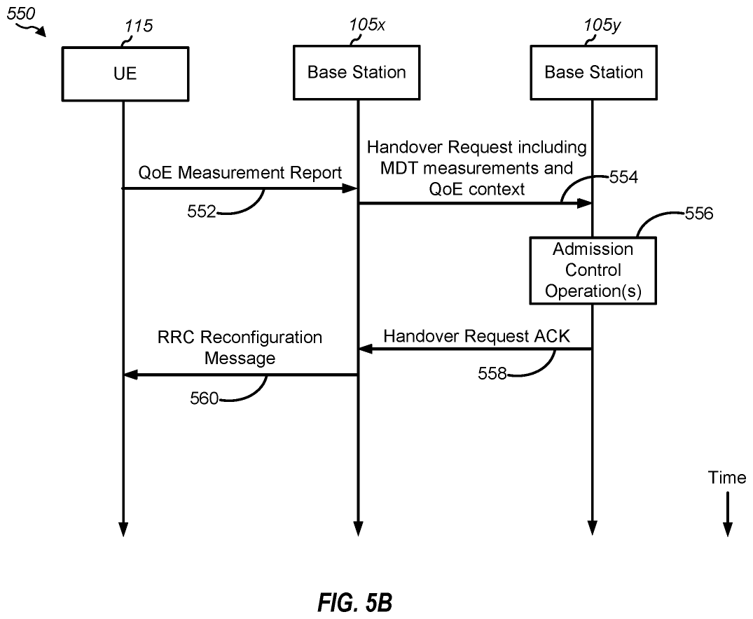

FIG. 5A is a ladder diagram illustrating operations 500 that may be performed by a wireless communications system according to some aspects of the disclosure. The operations 500 may be performed by one or more network devices, such as one or more servers and one or more base stations, and by a UE, such as the UE 115. The one or more servers may include an access and mobility management function (AMF) server 502 and a mobility management entity (MME) server 504. The one or more base stations may include the base station 105x (e.g., one of the base stations 105a-105e of FIG. 1) and the base station 105y (e.g., another of the base stations 105a-105e of FIG. 1). In the example of FIG. 5A, the base station 105x may correspond to or be associated with a next-generation radio access network (NG-RAN), and the base station 105y may correspond to or be associated with an evolved universal mobile telecommunications system (UMTS) terrestrial radio access (E-UTRA) network.

During operation, the base station 105x may communicate with the UE 115. For example, the base station 105 may configure the UE 115 with a first QoE configuration, and the UE 115 may perform one or more QoE measurements based on the first QoE configuration. The UE 115 may generate QoE data (such as a QoE measurement report) based on the one or more QoE measurements and may transmit the QoE data to the base station 105x (e.g., by transmitting the QoE measurement report 150 or another QoE measurement report). The base station 105x may receive the QoE data from the UE 115.

In some cases, the base station 105x may initiate a handover (e.g., based on the QoE data) of the UE 115 to another base station, such as the base station 105y. For example, the base station 105x may send a handover message to the AMF server 502, at 512. The handover message includes QoE context data associated with the UE 115. For example, the QoE context data may include the first QoE configuration associated with the UE 115.

In response to the handover message, the AMF server 502 may transmit a relocation request to the MME server 504, at 514. In response to the relocation request, the MME server 504 may communicate with the base station 105y in connection with the handover. For example, the MME server 504 may transmit a handover request to the base station 105y, at 516. The handover request may include the QoE context data. In some examples, the handover request may indicate one or more of an area scope associated with the QoE data, a collection entity (CE) address associated with the QoE context data (e.g., a network identifier of the UE 115), a service type associated with the QoE data, or an indication whether the UE 115 is configured for QoE measurement. The area scope may also be referred to herein as an area configuration. The area scope may include a list of cells at which QoE should be performed, or a geographical area in which QoE should be performed. Upon receiving an indication of the area scope, a base station may check whether the base station is within the list of cells (or within the geographical area).

The base station 105y may transmit a handover response to the MME server 504 (e.g., at 516). In some examples, the handover response indicates a QoE response. To illustrate, the handover response may indicate whether the base station 105y satisfies one or more QoE criteria specified by the handover response, such as whether the base station 105y is within the area scope specified by the handover request. To illustrate, the base station 105y may detect whether the area scope is satisfied and may transmit the handover response to the MME server 504 based on whether the area scope is satisfied. In one example, the base station 105y determines that the area scope is satisfied, and the handover response accepts the handover request. In another example, the base station 105y determines that the area scope is not satisfied, and the handover response rejects the handover request. In another example, the base station 105y determines that the area scope is not satisfied, and the handover response accepts the handover request and further indicates that the base station 105y does not support QoE reporting associated with the UE 115. Alternatively, or in addition, the handover response may indicate other information, such as whether the base station 105y is able to support the service type indicated by the handover request, as illustrative examples.

The MME server 504 may transmit a relocation response to the AMF server 502, at 518. Based on the relocation response, the AMF server 502 may transmit a handover command to the base station 105x, at 520. The base station 105x may receive the handover command from the AMF server 502 and may transmit a reconfiguration message (such as an RRC reconfiguration message) to the UE 115 based on the handover command, at 522. The reconfiguration message may initiate the handover from the base station 105x to the base station 105y.

In some examples, the operations 500 of FIG. 5A include an inter-RAT handover. For example, the base station 105x may be associated with a first wireless communication protocol (e.g., one of a 4G LTE wireless communication protocol or a 5G NR wireless communication protocol), and the base station 105y may be associated with a second wireless communication protocol (e.g., the other of the 4G LTE wireless communication protocol or the 5G NR wireless communication protocol) that is different than the first wireless communication protocol. In this case, the handover of the UE 115 from the base station 105x to the base station 105y corresponds to an inter-RAT handover.

One or more messages described with reference to FIG. 5A may include QoE context data associated with the UE 115. As a result, service quality or continuity in connection with a handover of the UE 115 may be improved as compared to other systems, such as systems that “start over” with QoE data during an inter-RAT handover.

FIG. 5B is a ladder diagram illustrating operations 550 that may be performed by a wireless communications system according to some aspects of the disclosure. The operations 550 may be performed by one or more network devices, such as the base station 105x (e.g., one of the base stations 105a-105e of FIG. 1) and the base station 105y (e.g., another of the base stations 105a-105e of FIG. 1), and by a UE, such as the UE 115.

The operations 550 may include transmitting a QoE measurement report (e.g., the QoE measurement report 150 or another QoE measurement report) by the UE 115 to the base station 105x, at 552. In one example, the QoE measurement report corresponds to the QoE measurement report described with reference to FIG. 5A.

The base station 105x may initiate a handover in response to the QoE measurement report, at 554. In some examples, the handover may correspond to the handover described with reference to FIG. 5A. Initiating the handover may include transmitting, to the base station 105y, a handover request indicating MDT measurements (which may be included in the QoE measurement report) and a QoE context of the UE 115, such as the QoE context described with reference to FIG. 5A.

The base station 105y may perform one or more admission control operations, at 556. For example, the base station 105y may determine, based on the handover request from the base station 105x, whether the base station 105y supports the first QoE configuration of the UE 115. The base station 105y may transmit a handover request acknowledgement (ACK) to the base station 105x, at 558. The handover request ACK may indicate whether the base station 105y is within the area scope indicated by the handover request, whether the base station 105y supports the first QoE configuration, or both, as illustrative examples.

The base station 105x may transmit an RRC reconfiguration message to the UE 115, at 560. The RRC reconfiguration message may cause the UE 115 to communicate with the base station 105y in connection with the handover.

One or more messages described with reference to FIG. 5B may include QoE context data associated with the UE 115. As a result, service quality or continuity in connection with a handover of the UE 115 may be improved as compared to other systems, such as systems that “start over” with QoE data during an inter-RAT handover.

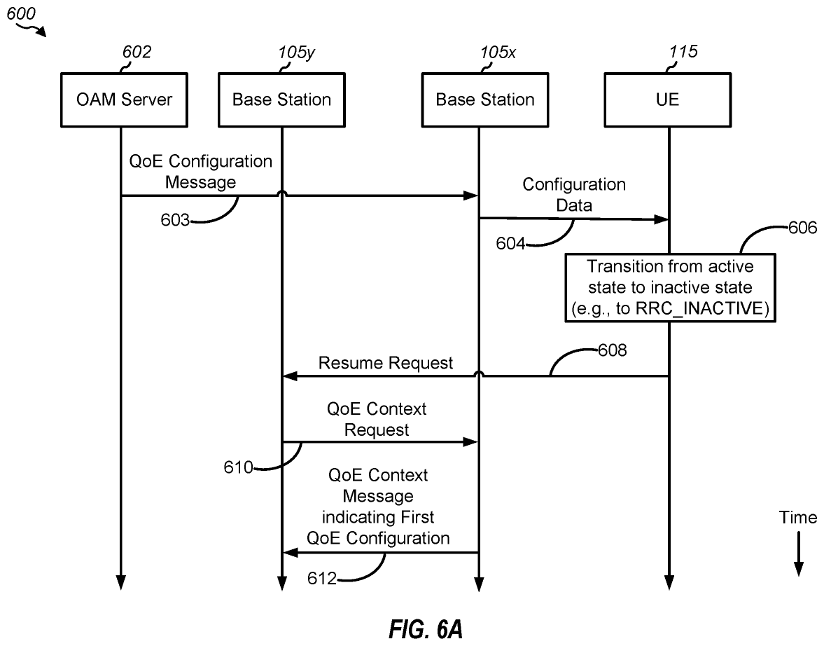

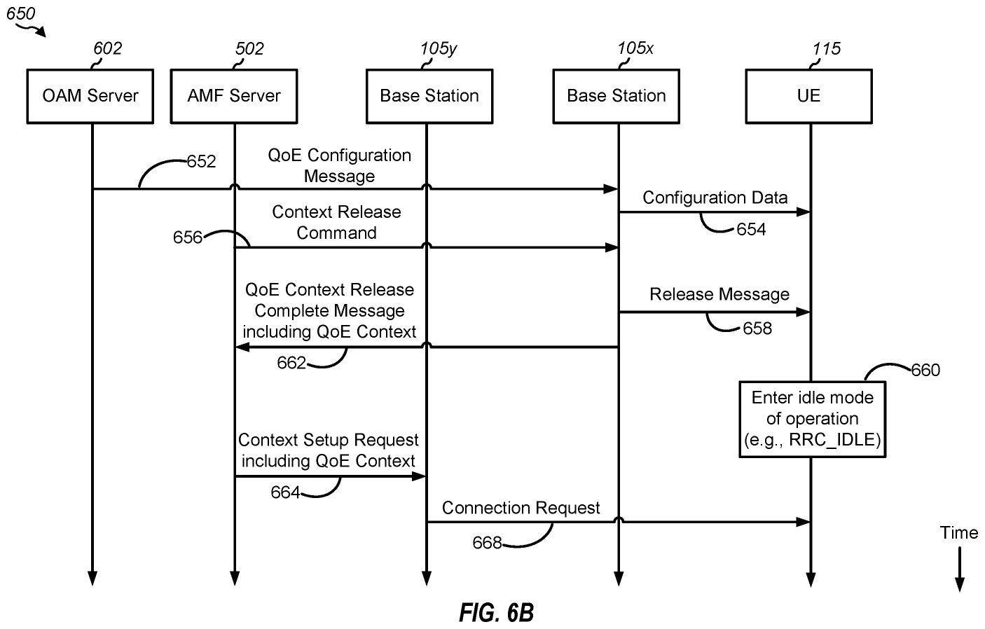

FIG. 6A is a ladder diagram illustrating operations 600 that may be performed by a wireless communications system according to some aspects of the disclosure. The operations 600 may be performed by one or more network devices, such as one or more servers and one or more base stations, and by a UE, such as the UE 115. The one or more servers may include an operations, administration, and maintenance (OAM) server 602. The one or more base stations may include a first network device, such as the base station 105x (e.g., one of the base stations 105a-105e of FIG. 1), and may further include a second network device, such as the base station 105y (e.g., another of the base stations 105a-105e of FIG. 1). In the example of FIG. 6A, the base station 105x may correspond to or be associated with a first next-generation radio access network (e.g., NG-RAN1), and the base station 105y may correspond to or be associated with a second NG-RAN (e.g., NG-RAN2).

The operations 600 may include transmitting, by the OAM server 602 to the base station 105x, a QoE configuration message, at 603. The QoE configuration message may include an indication of the first QoE configuration of the UE 115. In response to receiving the indication of the first QoE configuration from the OAM server 602, the base station 105x may transmit configuration data to the UE 115, at 604. The configuration data may indicate one or more QoE configurations, such as the first QoE configuration described with reference to any of FIGS. 3, 4, 5A, and 5B. The base station 105x may correspond to a serving base station of the UE 115.

The UE 115 may receive the configuration data and may perform QoE measurements based on the configuration data. In some examples, the UE 115 generates a QoE measurement report (e.g., the QoE measurement report 150 or another QoE measurement report) based on the first QoE configuration and transmits the QoE measurement report to the base station 105x.

In some cases, the UE 115 may transition from an active state to an inactive state (e.g., RRC INACTIVE), at 606. In some cases, in response to a mode transition of the UE 115 from the inactive state to the active state, the UE 115 may transmit a resume request to the base station 105y, at 608. Based on the mode transition of the UE 115, the base station 105x may receive, from the base station 105y, a QoE context request associated with the UE 115, at 610. Based on the QoE context request, the base station 105x may transmit, to the base station 105y, a QoE context message associated with the UE 115, at 612. The QoE context message may indicate the first QoE configuration associated with the UE 115. In some examples, the base station 105x stores the QoE configuration of the UE 115 after transmission of the resume request to enable the base station 105y to retrieve, via the QoE context request, the QoE context including the QoE configuration from the base station 105x.

One or more aspects of FIG. 6A may improve operation of a wireless communication system. For example, by including the first QoE configuration in the QoE context message, continuity of QoE operations may be improved, such as by providing the UE 115 with a more continuous level of QoE as compared to certain other systems, such as systems that reconfigure QoE at the UE 115 after a mode transition from an inactive state to an active state.

FIG. 6B is a ladder diagram illustrating operations 650 that may be performed by a wireless communications system according to some aspects of the disclosure. The operations 650 may be performed by one or more network devices, such as one or more servers and one or more base stations, and by a UE, such as the UE 115. The one or more servers may include the OAM server 602 and the AMF server 502. The one or more base stations may include a first network device, such as the base station 105x (e.g., one of the base stations 105a-105e of FIG. 1), and may further include a second network device, such as the base station 105y (e.g., another of the base stations 105a-105e of FIG. 1). In the example of FIG. 6B, the base station 105x may correspond to or be associated with a first next-generation radio access network (NG-RAN1), and the base station 105y may correspond to or be associated with a second NG-RAN (NG-RAN2).

The operations 650 may include transmitting, by the OAM server 602 to the base station 105x, a QoE configuration message, at 652. The QoE configuration message may include an indication of the first QoE configuration of the UE 115. In response to receiving the indication of the first QoE configuration from the OAM server 602, the base station 105x may transmit configuration data to the UE 115, at 654. The configuration data may indicate one or more QoE configurations, such as the first QoE configuration described with reference to any of FIGS. 3, 4, 5A, and 5B.

The UE 115 may receive the configuration data and may perform QoE measurements based on the configuration data. In some examples, the UE 115 generates a QoE measurement report (e.g., the QoE measurement report 150 or another QoE measurement report) based on the first QoE configuration and transmits the QoE measurement report to the base station 105x.

In some cases, the base station 105 may receive, from the AMF server 502, a context release command associated with the UE 115, at 656. For example, after a threshold period of inactivity by the UE 115, the base station 105x may transmit a context release request to the AMF server 502, and the AMF server 502 may transmit the context release command in response to the context release request. The AMF server 502 may store the QoE context and the first QoE configuration after receiving the context release request. In some examples, the context release request includes a QoE context associated with the UE 115, and the QOE context includes or indicates the first QoE configuration of the UE 115.

Based on the context release command, the base station 105 may transmit, to the UE 115, a release message, at 658. In some examples, transmitting the release message to the UE 115 causes the UE 115 to enter an idle mode of operation, at 660. The base station 105 may also transmit a QoE context release complete message associated with the UE to the AMF server 502, at 662. The QoE context release complete message may correspond to an ACK of the release message and may include the QoE context associated with the UE 115. The QoE context may include the first QoE configuration of the UE 115.

In some examples, the AMF server 502 transmits a context setup request to the base station 105y, at 664. For example, after operating in the idle mode, the UE 115 may perform a second RRC transition from the idle mode of operation to the active mode of operation, and the AMF server 502 may transmit the context setup request based on the second RRC transition.

In some implementations, the AMF server 502 forwards the QoE context message to the base station 105y based on the second RRC transition, in connection with the context setup request, and during an RRC setup procedure between the UE 115 and the base station 105y. The base station 105y may transmit, at 668, a connection setup request (e.g., an RRC setup request that initiates an RRC connection establishment operation) to the UE 115 based on receiving the context setup request from the AMF server 502. The base station 105y may transmit the connection setup request based on the QoE context indicated by the context setup request and may communicate with the UE 115 based on the QoE context indicated by the context setup request.

In some examples, the UE 115 transmits, to the base station 105y, an RRC connection message including a flag indicating whether the UE is configured for signaling-based QoE measurement or for management-based QoE measurement. In some examples, a modem of the UE 115 indicates, to an application layer of the UE 115, one or more of a QoE suspend, a QoE resume, or a QoE stop based on one or more of a change in RRC state of the UE 115 or an area indication associated with the UE 115. The application layer or operating system of the UE 115 may continue to perform QoE measurement until a notification is received from the modem of the UE 115.

One or more aspects of FIG. 6B may improve operation of a wireless communication system. For example, by including the first QoE configuration in the QoE context messages transmitted at 662 and at 664, continuity of QoE operations may be improved, such as by providing the UE 115 with a more continuous level of QoE as compared to certain other systems that reconfigure QoE after a mode transition to an idle mode of operation.

Although certain examples have been described separately for convenience, it is noted that such examples may be combined without departing from the scope of the disclosure. For example, any of the operations 300, 400, 500, 550, 600, and 650 may be combined with any others of the operations the operations 300, 400, 500, 550, 600, and 650 without departing from the scope of the disclosure.

FIG. 7 is a flow chart illustrating an example of a method 700 of wireless communication that may be performed by a UE according to some aspects of the disclosure. In some examples, the method 700 is performed by the UE 115.

The method 700 includes receiving, by a UE, a first message indicating one or more QoE configurations including at least a first QoE configuration for the UE, at 702. For example, the UE 115 may receive the first message indicating the first QoE configuration as described with reference to FIG. 3, at 310.

The method 700 further includes receiving, by the UE, a second message indicating a second QoE configuration for the UE, at 704. For example, the UE 115 may receive the second message indicating the second QoE configuration as described with reference to FIG. 3, at 320.

The method 700 further includes transmitting, by the UE, a QoE measurement report associated with a particular QoE configuration corresponding to one of the first QoE configuration or the second QoE configuration, at 706. The UE transmits the QoE measurement report based on one or more of a first priority associated with the first QoE configuration, a second priority associated with the second QoE configuration, or a QoE configuration threshold. In some examples, the QoE measurement report corresponds to one or both of the QoE measurement report 150 of FIGS. 1 and 2, the QoE measurement report described with reference to FIG. 3, at 330, another QoE measurement report, or a combination thereof.

To illustrate, in one example, the method 700 includes releasing the first QoE configuration and replacing the first QoE configuration by the second QoE configuration based on one or more of the second priority exceeding the first priority or a number of QoE configurations associated with the UE exceeding the QoE configuration threshold. In such examples, the QoE measurement report may include QoE measurements performed by the UE based on the first QoE configuration.

In another example, the method 700 includes releasing the second QoE configuration and maintaining the first QoE configuration based on one or more of the first priority exceeding the second priority or a number of QoE configurations associated with the UE exceeding the QoE configuration threshold. In such examples, the QoE measurement report may include QoE measurements performed by the UE based on the second QoE configuration.

In another example, the method 700 includes maintaining both the first QoE configuration and the second QoE configuration based on a number of QoE configurations associated with the UE failing to exceed the QoE configuration threshold. In such examples, the QoE measurement report may include QoE measurements performed by the UE based on one or both of the first QoE configuration or the second QoE configuration.

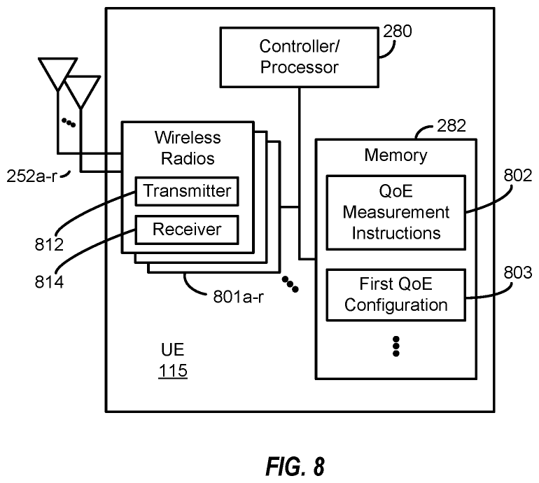

FIG. 8 is a block diagram illustrating an example of the UE 115 according to some aspects of the disclosure. The UE 115 may include one or more features described with reference to FIG. 2. For example, the UE 115 includes the controller/processor 280, which is configured to execute logic or computer instructions stored in the memory 282 and to control one or more components of UE 115 that provide the features and functionality of UE 115. UE 115, under control of controller/processor 280, transmits and receives signals via wireless radios 801a-r and antennas 252a-r. The wireless radios 801a-r may include a transmitter 812 and a receiver 814. In some examples, the transmitter 812 and the receiver 814 include one or more components illustrated in FIG. 2, such as modulator/demodulators 254a-r, MIMO detector 256, receive processor 258, transmit processor 264, TX MIMO processor 266, one or more other components, or a combination thereof. The transmitter 812 may be configured to transmit one or more signals or messages described herein (e.g., the QoE measurement report 150), and the receiver 814 may be configured to receive one or more signals or messages described herein.

The memory 282 may store instructions executable by the controller/processor 280 to perform, initiate, or control one or more operations described herein. To illustrate, the memory 282 may store QoE measurement instructions 802 executable by the controller/processor 280 to perform QoE measurements, to generate QoE measurement reports, to transmit a QoE measurement report, to perform one or more other operations, or a combination thereof. In one example, the memory 282 stores an indication of a first QoE configuration 803, and the controller/processor 280 may execute the QoE measurement instructions 802 to perform QoE measurements based on the first QoE configuration 803. In some examples, the first QoE configuration 803 corresponds to the first QoE configuration described with reference to any of FIGS. 3-7.

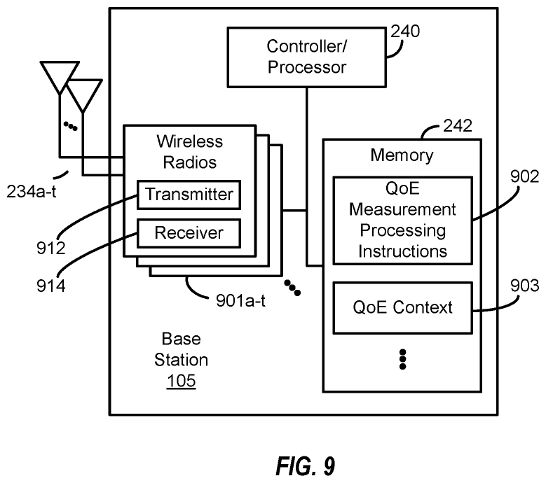

FIG. 9 is a block diagram an example of the base station 105 according to some aspects of the disclosure. One or more features of the base station 105 may be as described with reference to FIG. 2. For example, base station 105 includes the controller/processor 240, which is configured to execute logic or computer instructions stored in memory 242 and to control one or more components of base station 105 that provide the features and functionality of base station 105. Base station 105, under control of controller/processor 240, transmits and receives signals via wireless radios 901a-t and antennas 234a-t. Wireless radios 901a-t may include a transmitter 912 and a receiver 914. In some examples, the transmitter 912 and the receiver 914 include one or more components illustrated in FIG. 2, such as modulator/demodulators 232a-t, MIMO detector 236, receive processor 238, transmit processor 220, TX MIMO processor 230, one or more other components, or a combination thereof. The transmitter 912 may be configured to transmit one or more signals or messages described herein, and the receiver 914 may be configured to receive one or more signals or messages described herein (e.g., the QoE measurement report 150).

The memory 242 may store instructions executable by the controller/processor 240 to perform, initiate, or control one or more operations described herein. To illustrate, the memory 242 may store QoE measurement processing instructions 902 executable by the controller/processor 240 to receive and process a QoE measurement report received from the UE 115. FIG. 9 also illustrates that the memory 242 may store a QoE context 903 associated with the UE 115. The QoE context 903 may correspond to any of the QoE contexts described with reference to FIGS. 3-7.

According to some further aspects, in a first aspect, a method includes receiving, by a UE, a first message indicating one or more QoE configurations including at least a first QoE configuration for the UE. The method further includes receiving, by the UE, a second message indicating a second QoE configuration for the UE. The method further includes transmitting, by the UE based on one or more of a first priority associated with the first QoE configuration, a second priority associated with the second QoE configuration, or a QoE configuration threshold, a QoE measurement report associated with a particular QoE configuration corresponding to one of the first QoE configuration or the second QoE configuration.

In a second aspect, alternatively or in addition to the first aspect, the UE receives the first message and the second message from a network device, and the network device and the UE operate in accordance with a wireless communication protocol that specifies that the network device is to configure the UE with one or more of the first priority, the second priority, or the QoE configuration threshold.

In a third aspect, alternatively or in addition to one or more of the first through second aspects, one or more of the first priority, the second priority, or the QoE configuration threshold are specific to the UE.

In a fourth aspect, alternatively or in addition to one or more of the first through third aspects, the method includes transmitting a release notification with the QoE measurement report indicating release of the first QoE configuration or the second QoE configuration.

In a fifth aspect, alternatively or in addition to one or more of the first through fourth aspects, the method includes executing a first application and a second application, the first application associated with the first QoE configuration and a first service type, and the second application associated with the second QoE configuration and a second service type.

In a sixth aspect, alternatively or in addition to one or more of the first through fifth aspects, the method includes releasing the first QoE configuration and replacing the first QoE configuration by the second QoE configuration based on one or more of the second priority exceeding the first priority or a number of QoE configurations associated with the UE exceeding the QoE configuration threshold.

In a seventh aspect, alternatively or in addition to one or more of the first through sixth aspects, the method includes releasing the second QoE configuration and maintaining the first QoE configuration based on one or more of the first priority exceeding the second priority or a number of QoE configurations associated with the UE exceeding the QoE configuration threshold.

In an eighth aspect, alternatively or in addition to one or more of the first through seventh aspects, the method includes maintaining both the first QoE configuration and the second QoE configuration based on a number of QoE configurations associated with the UE failing to exceed the QoE configuration threshold.

In a ninth aspect, alternatively or in addition to one or more of the first through eighth aspects, a non-transitory computer readable medium stores instructions executable by a processor to perform operations. The operations include receiving, by a UE, a first message indicating one or more QoE configurations including at least a first QoE configuration for the UE. The operations further include receiving, by the UE, a second message indicating a second QoE configuration for the UE. The operations further include, based on one or more of a first priority associated with the first QoE configuration, a second priority associated with the second QoE configuration, or a QoE configuration threshold, transmitting, by the UE, a QoE measurement report associated with a particular QoE configuration corresponding to one of the first QoE configuration or the second QoE configuration.

In a tenth aspect, alternatively or in addition to one or more of the first through ninth aspects, the UE receives the first message and the second message from a network device, and the network device and the UE operate in accordance with a wireless communication protocol that specifies that the network device is to configure the UE with one or more of the first priority, the second priority, or the QoE configuration threshold.

In an eleventh aspect, alternatively or in addition to one or more of the first through tenth aspects, one or more of the first priority, the second priority, or the QoE configuration threshold are specific to the UE.

In a twelfth aspect, alternatively or in addition to one or more of the first through eleventh aspects, the operations further include transmitting a release notification with the QoE measurement report indicating release of the first QoE configuration or the second QoE configuration.

In a thirteenth aspect, alternatively or in addition to one or more of the first through twelfth aspects, the operations further include executing a first application and a second application, the first application associated with the first QoE configuration and a first service type, and the second application associated with the second QoE configuration and a second service type.

In a fourteenth aspect, alternatively or in addition to one or more of the first through thirteenth aspects, the operations further include releasing the first QoE configuration and replacing the first QoE configuration by the second QoE configuration based on one or more of the second priority exceeding the first priority or a number of QoE configurations associated with the UE exceeding the QoE configuration threshold.

In a fifteenth aspect, alternatively or in addition to one or more of the first through fourteenth aspects, the operations further include releasing the second QoE configuration and maintaining the first QoE configuration based on one or more of the first priority exceeding the second priority or a number of QoE configurations associated with the UE exceeding the QoE configuration threshold.

In a sixteenth aspect, alternatively or in addition to one or more of the first through fifteenth aspects, the operations further include maintaining both the first QoE configuration and the second QoE configuration based on a number of QoE configurations associated with the UE failing to exceed the QoE configuration threshold.

In a seventeenth aspect, alternatively or in addition to one or more of the first through sixteenth aspects, an apparatus includes a receiver configured to receive a first message indicating one or more QoE configurations including at least a first QoE configuration for a UE and to receive a second message indicating a second QoE configuration for the UE. The apparatus further includes a transmitter configured to transmit, based on one or more of a first priority associated with the first QoE configuration, a second priority associated with the second QoE configuration, or a QoE configuration threshold, a QoE measurement report associated with a particular QoE configuration corresponding to one of the first QoE configuration or the second QoE configuration.

In an eighteenth aspect, alternatively or in addition to one or more of the first through seventeenth aspects, the receiver is further configured to receive the first message and the second message from a network device, and the network device and the UE are configured to operate in accordance with a wireless communication protocol that specifies that the network device is to configure the UE with one or more of the first priority, the second priority, or the QoE configuration threshold.

In a nineteenth aspect alternatively or in addition to one or more of the first through eighteenth aspects, one or more of the first priority, the second priority, or the QoE configuration threshold are specific to the UE.

In a twentieth aspect, alternatively or in addition to one or more of the first through nineteenth aspects, the transmitter is further configured to transmit a release notification with the QoE measurement report indicating release of the first QoE configuration or the second QoE configuration.

In a twenty-first aspect, alternatively or in addition to one or more of the first through twentieth aspects, the apparatus includes one or more processors configured to execute a first application and a second application, the first application associated with the first QoE configuration and a first service type, and the second application associated with the second QoE configuration and a second service type.

In a twenty-second aspect, alternatively or in addition to one or more of the first through twenty-first aspects, the first QoE configuration is released and replaced by the second QoE configuration based on one or more of the second priority exceeding the first priority or a number of QoE configurations associated with the UE exceeding the QoE configuration threshold.

In a twenty-third aspect, alternatively or in addition to one or more of the first through twenty-second aspects, the second QoE configuration is released and the first QoE configuration is maintained based on one or more of the first priority exceeding the second priority or a number of QoE configurations associated with the UE exceeding the QoE configuration threshold.

In a twenty-fourth aspect, alternatively or in addition to one or more of the first through twenty-third aspects, both the first QoE configuration and the second QoE configuration are maintained based on a number of QoE configurations associated with the UE failing to exceed the QoE configuration threshold.

In a twenty-fifth aspect, alternatively or in addition to one or more of the first through twenty-fourth aspects, an apparatus includes means for receiving a first message indicating one or more QoE configurations including at least a first QoE configuration for a UE and for receiving a second message indicating a second QoE configuration for the UE. The apparatus further includes means for transmitting, based on one or more of a first priority associated with the first QoE configuration, a second priority associated with the second QoE configuration, or a QoE configuration threshold, a QoE measurement report associated with a particular QoE configuration corresponding to one of the first QoE configuration or the second QoE configuration.

In a twenty-sixth aspect, alternatively or in addition to one or more of the first through twenty-fifth aspects, the means for transmitting is configured to transmit a release notification with the QoE measurement report indicating release of the first QoE configuration or the second QoE configuration.

In a twenty-seventh aspect, alternatively or in addition to one or more of the first through twenty-sixth aspects, the apparatus includes means for executing a first application and a second application, the first application associated with the first QoE configuration and a first service type, and the second application associated with the second QoE configuration and a second service type.

In a twenty-eighth aspect, alternatively or in addition to one or more of the first through twenty-seventh aspects, the first QoE configuration is released and replaced by the second QoE configuration based on one or more of the second priority exceeding the first priority or a number of QoE configurations associated with the UE exceeding the QoE configuration threshold.

In a twenty-ninth aspect, alternatively or in addition to one or more of the first through twenty-eighth aspects, the second QoE configuration is released and the first QoE configuration is maintained based on one or more of the first priority exceeding the second priority or a number of QoE configurations associated with the UE exceeding the QoE configuration threshold.

In a thirtieth aspect, alternatively or in addition to one or more of the first through twenty-ninth aspects, both the first QoE configuration and the second QoE configuration are maintained based on a number of QoE configurations associated with the UE failing to exceed the QoE configuration threshold.

In a thirty-first aspect, alternatively or in addition to one or more of the first through thirtieth aspects, an apparatus for wireless communication includes a receiver configured to receive, at a UE, configuration data indicating one or more QoE configurations including at least a first QoE configuration. The receiver is further configured to perform, based on the first QoE configuration, QoE measurements associated with a wireless communication network and a base station. The apparatus further includes a transmitter configured to transmit, by the UE based on the one or more QoE measurements, a QoE measurement report with one or more of an indication of a network type of the wireless communication network or cell information associated with the base station.

In a thirty-second aspect, alternatively or in addition to one or more of the first through thirty-first aspects, the indication of the network type includes a flag having a value indicating whether the wireless communication network corresponds to a fourth generation long term evolution (4G LTE) wireless communication network or a fifth generation new radio (5G NR) wireless communication network.

In a thirty-third aspect, alternatively or in addition to one or more of the first through thirty-second aspects, the receiver is further configured to receive a reconfiguration message indicating a handover from a first cell corresponding to the base station to a second cell and to transmit the indication in response to the handover.

In a thirty-fourth aspect, alternatively or in addition to one or more of the first through thirty-third aspects, the first cell is associated with a first radio access technology (RAT), and the second cell is associated with a second RAT different than the first RAT.

In a thirty-fifth aspect, alternatively or in addition to one or more of the first through thirty-fourth aspects, the first cell and the second cell are associated with a common radio access technology (RAT) or with different RATs.

In a thirty-sixth aspect, alternatively or in addition to one or more of the first through thirty-fifth aspects, one or more of the receiver or the transmitter are further configured to operate based on a multi-radio access network dual connectivity (MR-DC) mode, the base station corresponds to a master node (MN) associated with the MR-DC mode, and the cell information includes a master node cell global identifier (MN CGI) of the MN.

In a thirty-seventh aspect, alternatively or in addition to one or more of the first through thirty-sixth aspects, one or more of the receiver or the transmitter are further configured to communicate with a secondary node (SN) in connection with the MR-DC mode, the cell information includes a secondary node cell global identifier (SN CGI) of the SN, and the apparatus includes a processor configured to remove the SN from the MR-DC mode and to remove the SN CGI from the QoE measurement report.

In a thirty-eighth aspect, alternatively or in addition to one or more of the first through thirty-seventh aspects, a method of wireless communication includes receiving, by a first base station, a QoE measurement report from a UE based on a QoE configuration of the UE. The method further includes, based on the QoE configuration, transmitting, by the first base station to a server, a handover message that includes QoE context and QoE reporting data associated with the UE. The handover message is associated with a handover of the UE from the first base station to a second base station, and transmission of the QoE context and QoE reporting data with the handover message enables the second base station to use the QoE configuration based on a determination that an area scope associated with the QoE configuration is satisfied. The method further includes receiving a handover command from the server, and based on the handover command, transmitting a reconfiguration message to the UE to initiate the handover of the UE from the first base station to the second base station.

In a thirty-ninth aspect, alternatively or in addition to one or more of the first through thirty-eighth aspects, the server corresponds to an access and mobility management function (AMF) server.

In a fortieth aspect, alternatively or in addition to one or more of the first through thirty-ninth aspects, the handover message further indicates one or more of the area scope, a collection entity (CE) address associated with the QoE configuration, a service type associated with the QoE configuration, or an indication whether the UE is configured for QoE measurement.

In a forty-first aspect, alternatively or in addition to one or more of the first through fortieth aspects, the first base station is associated with a first wireless communication protocol, and the second base station is associated with a second wireless communication protocol that is different than the first wireless communication protocol.

In a forty-second aspect, alternatively or in addition to one or more of the first through forty-first aspects, the first wireless communication protocol includes one of a fourth generation long term evolution (4G LTE) wireless communication protocol or a fifth generation new radio (5G NR) wireless communication protocol, and the second wireless communication protocol includes the other of the 4G LTE wireless communication protocol or the 5G NR wireless communication protocol.

In a forty-third aspect, alternatively or in addition to one or more of the first through forty-second aspects, an apparatus for wireless communication includes a transmitter and a receiver. The receiver is configured to receive, at a first network device based on a radio resource control (RRC) mode transition of a UE, a QoE context associated with the UE from a serving base station of the UE or from a server. The QOE context indicates a QoE configuration associated with the UE, One or both of the transmitter or the receiver are configured to communicate with the UE, after an RRC resume operation associated with the UE or after an RRC connection establishment operation associated with the UE, based on the QoE context.

In a forty-fourth aspect, alternatively or in addition to one or more of the first through forty-third aspects, the RRC transition is from an active state to an inactive state.

In a forty-fifth aspect, alternatively or in addition to one or more of the first through forty-fourth aspects, the receiver is further configured to receive, after the RRC transition, a resume request from the UE based on the RRC transition from the active state to the inactive state.

In a forty-sixth aspect, alternatively or in addition to one or more of the first through forty-fifth aspects, the transmitter is further configured to transmit, based on the resume request, a QoE context request to the serving base station, and the first network device receives the QoE context from the serving base station based on the QoE context request.

In a forty-seventh aspect, alternatively or in addition to one or more of the first through forty-sixth aspects, the serving base station is configured to store the QoE configuration of the UE after transmission of the resume request to enable the first network device to retrieve, via the QoE context request, the QoE context including the QoE configuration from the serving base station.

In a forty-eighth aspect, alternatively or in addition to one or more of the first through forty-seventh aspects, the RRC transition is from an active mode of operation to an idle mode of operation of the UE.

In a forty-ninth aspect, alternatively or in addition to one or more of the first through forty-eighth aspects, the receiver is further configured to receive the QoE context from the server with a context setup request.

In a fiftieth aspect, alternatively or in addition to one or more of the first through forty-ninth aspects, the server corresponds to an access and mobility management function (AMF) server.

In a fifty-first aspect, alternatively or in addition to one or more of the first through fiftieth aspects, the AMF server is configured to receive a context release request from the serving base station, the context release request indicates the QoE context and the QoE configuration, and the AMF server is further configured to store the QoE context and the QoE configuration after receiving the context release request.

In a fifty-second aspect, alternatively or in addition to one or more of the first through fifty-first aspects, based on a second RRC transition of the UE from an idle mode of operation to an active mode of operation of the UE and during an RRC setup procedure between the UE and the first network device, the AMF server is configured to forward the QOE context and the QoE configuration to the first network device.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

One or more components, functional blocks, and modules described herein (e.g., the components, functional blocks, and modules in FIG. 2) may include one or more processors, electronics devices, hardware devices, electronics components, logical circuits, memories, software codes, firmware codes, etc., or any combination thereof. In addition, one or more features described herein may be implemented via specialized processor circuitry, via executable instructions, and/or combinations thereof.

Those of skill would further appreciate that the various illustrative logical blocks, modules, circuits, and operations (e.g., the logical blocks of FIGS. 7 and 8) described herein may be implemented using electronic hardware, computer software, or combinations of both. To further illustrate, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The operations of a method or process described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media, including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. An apparatus for wireless communication, comprising:
a receiver configured to receive, at a user equipment (UE), configuration data indicating one or more quality of experience (QoE) configurations including at least a first QoE configuration and further configured to perform, based on the first QoE configuration, one or more QoE measurements associated with a wireless communication network and a base station; and
a transmitter configured to transmit, by the UE based on the one or more QoE measurements, a QoE measurement report with one or more of an indication of a network type of the wireless communication network or cell information associated with the base station.

2. The apparatus of claim 1, wherein the indication of the network type includes a flag having a value indicating whether the wireless communication network corresponds to a fourth generation long term evolution (4G LTE) wireless communication network or a fifth generation new radio (5G NR) wireless communication network.

3. The apparatus of claim 1, wherein the receiver is further configured to receive a reconfiguration message indicating a handover from a first cell corresponding to the base station to a second cell and to transmit the indication in response to the handover.

4. The apparatus of claim 3, wherein the first cell is associated with a first radio access technology (RAT), and wherein the second cell is associated with a second RAT different than the first RAT.

5. The apparatus of claim 3, wherein the first cell and the second cell are associated with a common radio access technology (RAT).

6. The apparatus of claim 1, wherein one or more of the receiver or the transmitter are further configured to operate based on a multi-radio access network dual connectivity (MR-DC) mode, wherein the base station corresponds to a master node (MN) associated with the MR-DC mode, and wherein the cell information includes a master node cell global identifier (MN CGI) of the MN.

7. The apparatus of claim 6, wherein one or more of the receiver or the transmitter are further configured to communicate with a secondary node (SN) in connection with the MR-DC mode, wherein the cell information includes a secondary node cell global identifier (SN CGI) of the SN, and further comprising a processor configured to remove the SN from the MR-DC mode and to remove the SN CGI from the QoE measurement report.

8. An apparatus for wireless communication, comprising:
a transmitter; and
a receiver configured to receive, at a first network device based on a radio resource control (RRC) mode transition of a user equipment (UE), a quality of experience (QoE) context associated with the UE from a serving base station of the UE or from a server, wherein the QOE context indicates a QoE configuration associated with the UE,
wherein one or both of the transmitter or the receiver are configured to communicate with the UE, after an RRC resume operation associated with the UE or after an RRC connection establishment operation associated with the UE, based on the QoE context.

9. The apparatus of claim 8, wherein the RRC transition is from an active state to an inactive state.

10. The apparatus of claim 9, wherein the receiver is further configured to receive, after the RRC transition, a resume request from the UE based on the RRC transition from the active state to the inactive state.

11. The apparatus of claim 10, wherein the transmitter is further configured to transmit, based on the resume request, a QoE context request to the serving base station, wherein the first network device receives the QoE context from the serving base station based on the QoE context request.

12. The apparatus of claim 11, wherein the serving base station is configured to store the QoE configuration of the UE after transmission of the resume request to enable the first network device to retrieve, via the QoE context request, the QoE context including the QoE configuration from the serving base station.

13. The apparatus of claim 8, wherein the RRC transition is from an active mode of operation to an idle mode of operation of the UE.

14. The apparatus of claim 13, wherein the receiver is further configured to receive the QoE context from the server with a context setup request.

15. The apparatus of claim 8, wherein the server corresponds to an access and mobility management function (AMF) server.

16. The apparatus of claim 15, wherein the AMF server is configured to receive a context release request from the serving base station, wherein the context release request indicates the QoE context and the QoE configuration, and wherein the AMF server is further configured to store the QoE context and the QoE configuration after receiving the context release request.

17. The apparatus of claim 16, wherein, based on a second RRC transition of the UE from an idle mode of operation to an active mode of operation of the UE and during an RRC setup procedure between the UE and the first network device, the AMF server is configured to forward the QOE context and the QoE configuration to the first network device.

18. A method of wireless communication, comprising:
receiving, by a user equipment (UE), a first message indicating one or more quality of experience (QoE) configurations including at least a first QoE configuration for the UE;
receiving, by the UE, a second message indicating a second QoE configuration for the UE; and
based on one or more of a first priority associated with the first QoE configuration, a second priority associated with the second QoE configuration, or a QoE configuration threshold, transmitting, by the UE, a QoE measurement report associated with a particular QoE configuration corresponding to one of the first QoE configuration or the second QoE configuration.

19. The method of claim 18, wherein the UE receives the first message and the second message from a network device, and wherein the network device and the UE operate in accordance with a wireless communication protocol that specifies that the network device is to configure the UE with one or more of the first priority, the second priority, or the QoE configuration threshold.

20. The method of claim 18, wherein one or more of the first priority, the second priority, or the QoE configuration threshold are specific to the UE.

21. The method of claim 18, further comprising transmitting a release notification with the QoE measurement report indicating release of the first QoE configuration or the second QoE configuration.

22. The method of claim 18, further comprising executing a first application and a second application, the first application associated with the first QoE configuration and a first service type, and the second application associated with the second QoE configuration and a second service type.

23. The method of claim 18, further comprising releasing the first QoE configuration and replacing the first QoE configuration by the second QoE configuration based on one or more of the second priority exceeding the first priority or a number of QoE configurations associated with the UE exceeding the QoE configuration threshold.

24. The method of claim 18, further comprising releasing the second QoE configuration and maintaining the first QoE configuration based on one or more of the first priority exceeding the second priority or a number of QoE configurations associated with the UE exceeding the QoE configuration threshold.

25. The method of claim 18, further comprising maintaining both the first QoE configuration and the second QoE configuration based on a number of QoE configurations associated with the UE failing to exceed the QoE configuration threshold.

26. A method of wireless communication, comprising:
receiving, by a first base station, a quality of experience (QoE) measurement report from a user equipment (UE) based on a QoE configuration of the UE;
based on the QoE configuration, transmitting, by the first base station to a server, a handover message that includes QoE context and QoE reporting data associated with the UE, wherein the handover message is associated with a handover of the UE from the first base station to a second base station, and wherein transmission of the QoE context and QoE reporting data with the handover message enables the second base station to use the QoE configuration based on a determination that an area scope associated with the QoE configuration is satisfied;
receiving a handover command from the server; and
based on the handover command, transmitting a reconfiguration message to the UE to initiate the handover of the UE from the first base station to the second base station.

27. The method of claim 26, wherein the server corresponds to an access and mobility management function (AMF) server.

28. The method of claim 26, wherein the handover message further indicates one or more of the area scope, a collection entity (CE) address associated with the QoE configuration, a service type associated with the QoE configuration, or an indication whether the UE is configured for QoE measurement.

29. The method of claim 26, wherein the first base station is associated with a first wireless communication protocol, and wherein the second base station is associated with a second wireless communication protocol that is different than the first wireless communication protocol.

30. The method of claim 29, wherein the first wireless communication protocol includes one of a fourth generation long term evolution (4G LTE) wireless communication protocol or a fifth generation new radio (5G NR) wireless communication protocol, and wherein the second wireless communication protocol includes the other of the 4G LTE wireless communication protocol or the 5G NR wireless communication protocol.
